(19) United States
(12) Patent Application Publication
(10) Pub. No.: US 2026/0332095 A1
(43) Pub. Date: Oct. 22, 2026

(54) PACKAGE SEALING PERFORMANCE TEST SYSTEM FOR PHOTOVOLTAIC PACKAGING COMPONENT

(71) Applicant: Jiangsu Goodsun New Energy Co., Ltd., Yixing City (CN)

(72) Inventor: Chao JIANG, Yixing City (CN)

(21) Appl. No.: 19/632,387

(22) Filed: Mar. 29, 2026

(30) Foreign Application Priority Data
Apr. 2, 2025 (CN) 2025104057613

(51) Int. Cl. H02S 50/15; G01M 3/32

(52) U.S. Cl. CPC H02S 50/15; G01M 3/3236

(57) ABSTRACT

The present disclosure belongs to the technical field of performance testing for a photovoltaic packaging component. Specifically, a package sealing performance test system for a photovoltaic packaging component includes a basic inspection output unit, a preliminary analysis and determination unit, a package sealing performance test unit, a pressure control stability evaluation unit, and a test management terminal. According to the present disclosure, the preliminary analysis and determination unit is configured to reasonably determine a necessity degree of a package sealing performance test for the photovoltaic packaging component, and avoid wasting manpower and material resources by unnecessary testing. During the generation of a sealing low-hidden-danger signal, a water vapor permeability resistance condition of the photovoltaic packaging component is tested by simulating high humidity and pressure conditions in an actual use environment, and a quantitative basis is provided for the sealing performance evaluation.

### CROSS-REFERENCE TO RELATED APPLICATIONS

This application claims priority to Chinese Patent Application No. 202510405761.3, filed on Apr. 2, 2025, the content of which is incorporated herein by reference in its entirety.

### TECHNICAL FIELD

The present disclosure relates to the technical field of photovoltaic packaging component performance testing, and specifically, to a package sealing performance test system for a photovoltaic packaging component.

### BACKGROUND

A photovoltaic packaging component refers to a component configured for packaging materials such as a photovoltaic cell piece, glass, and a back plate together to form a photovoltaic module with a power generation function. The packaging of the photovoltaic module is very important to protect the cell piece, improve the mechanical strength of the module, prolong the service life, and ensure the power generation efficiency. The poor package sealing performance will lead to the intrusion of external factors such as moisture and humidity, thus affecting the performance and life of the photovoltaic cell piece.

At present, when the package sealing performance of the photovoltaic packaging component is tested, it is difficult to combine a test necessity analysis and an automatic test evaluation analysis of the sealing performance to improve the test efficiency and ensure the accuracy of test results, and it is impossible to comprehensively and effectively monitor the test process and reasonably feedback the abnormal situation. It is difficult for test management personnel to suspend the test process in time and make corresponding improvement measures, which is not conducive to improving the accuracy of the test results and reducing the difficulty of test supervision.

A solution is currently provided for the above-mentioned technical defects.

### SUMMARY

An objective of the present disclosure is to provide a package sealing performance test system for a photovoltaic packaging component, solving problems in the prior art that it is difficult to combine a test necessity analysis and an automatic test evaluation analysis of sealing performance to improve the test efficiency and ensure the accuracy of test results, and it is impossible to comprehensively and effectively monitor a test process and reasonably feedback an abnormal situation, which is not conducive to improving the accuracy of the test results and reducing the difficulty of test supervision.

In order to achieve the above-mentioned objective, the present disclosure provides a following technical solution:

A package sealing performance test system for a photovoltaic packaging component includes a basic inspection output unit, a preliminary analysis and determination unit, a package sealing performance test unit, a pressure control stability evaluation unit, and a test management terminal. The basic inspection output unit is configured to collect a surface image of a photovoltaic packaging component and send the surface image of the photovoltaic packaging component to the preliminary analysis and determination unit. The preliminary analysis and determination unit preliminarily determines a sealing hidden danger of the photovoltaic packaging component based on the surface image of the photovoltaic packaging component, generates a sealing high-hidden-danger signal or a sealing low-hidden-danger signal based on the sealing hidden danger, and sends the sealing high-hidden-danger signal or the sealing low-hidden-danger signal to the test management terminal.

During the generation of the sealing low-hidden-danger signal, a package sealing performance test for the photovoltaic packaging component is performed through the package sealing performance test unit, the package sealing performance is determined after the test is completed, and a package sealing performance determination result is sent to the test management terminal. The pressure control stability evaluation unit performs pressure control monitoring on a circulating pressure pump, evaluates the pressure control stability of the circulating pressure pump, generates a pressure control qualified signal or a pressure control abnormal signal accordingly, and sends the pressure control qualified signal or the pressure control abnormal signal to the test management terminal.

Further, testing steps of the package sealing performance test unit are as follows:

Sample fixation: The photovoltaic packaging component is fixed to an adhesive layer test frame to keep a sample stable during the test process.

Placement in a pressure air chamber: The fixed sample is placed in the pressure air chamber, where the pressure air chamber is a sealed space for simulating an air pressure condition in an actual use environment and performing a water vapor permeability test.

Humidity gas injection: Humidity gas with a humidity of 80% is injected into a test gas storage tank.

Circulating pressure pump startup: The circulating pressure pump is started to work, extracts the humidity gas from the test gas storage tank, and continuously inputs the humidity gas with pressure into an inner cavity of the pressure air chamber, and a pressure is controlled between 1.5×10⁵ Pa and 2.0×10⁵ Pa.

Observation and value recording: After 30 minutes of operation, a value of a hygrometer in a sealed test chamber communicating with the pressure air chamber is collected, and a difference of humidity values before and after the test is recorded.

Performance determination: According to a humidity value difference, the package sealing performance of the photovoltaic packaging component is determined.

Further, during the performance determination, if the humidity value difference is less than or equal to a preset humidity value difference threshold, it is determined that the package sealing performance of the photovoltaic packaging component is qualified; and if the humidity value difference is larger than the preset humidity value difference threshold, it is determined that the package sealing performance of the photovoltaic packaging component is not qualified.

Further, a specific determination process of the preliminary analysis and determination unit includes:
recognizing a crack on a surface of the photovoltaic packaging component based on the surface image of the photovoltaic packaging component, and if the crack exists on the surface of the photovoltaic packaging component, generating the sealing high-hidden-danger signal; and
if no crack exists on the surface of the photovoltaic packaging component, recognizing bubbles on a bonding surface of colloid, glass, and a back plate based on the surface image of the photovoltaic packaging component, and if no bubbles exist on the bonding surface of the colloid, the glass, and the back plate, generating the sealing low-hidden-danger signal.

Further, if the bubbles exist on the bonding surface of the colloid, the glass, and the back plate, a volume of the corresponding bubbles is collected and marked as a bubble occupied space value, and the bubble occupied space value is numerically compared with a preset bubble occupied space threshold. If the bubble occupied space value exceeds the preset bubble occupied space threshold, the corresponding bubbles are marked as hidden danger bubbles.

If the hidden danger bubbles exist on the bonding surface of the colloid, the glass, and the back plate, the sealing high-hidden-danger signal is generated. If no hidden danger bubbles exist on the bonding surface of the colloid, the glass, and the back plate, the number of the bubbles on the bonding surface of the colloid, the glass, and the back plate is collected and marked as a bubble number detection value, and a proportion of a distribution area of the bubbles on the bonding surface of the colloid, the glass, and the back plate is marked as a bubble distribution value. The bubble number detection value and the bubble distribution value are numerically compared with a preset bubble number detection threshold and a preset bubble distribution threshold respectively. If the bubble number detection value or the bubble distribution value exceeds the corresponding preset threshold, the sealing high-hidden-danger signal is generated. If both the bubble number detection value and the bubble distribution value do not exceed the corresponding preset thresholds, the sealing low-hidden-danger signal is generated.

Further, a specific analysis process of the pressure control stability evaluation unit includes:
acquiring a pressure curve of the humidity gas outputted by the circulating pressure pump in a unit time, and placing the pressure curve into a first quadrant of a rectangular coordinate system, with a starting point of the pressure curve located on a Y-axis, where an X-axis of the rectangular coordinate system represents time, and the Y-axis represents pressure;
in the first quadrant of the rectangular coordinate system, drawing an upper ray and a lower ray that are parallel to the X-axis with endpoints on the Y-axis, where a Y-axis coordinate value corresponding to the upper ray is 2.0×10⁵ Pa, and a Y-axis coordinate value corresponding to the lower ray is 1.5×10⁵ Pa; and defining the upper ray and the lower ray as a first ray and a second ray respectively; and
acquiring and marking a Y-direction length value of a segment of the pressure curve that is not located between the first ray and the second ray as a pressure control deviation duration value, numerically comparing the pressure control deviation duration value with a preset pressure control deviation duration threshold, and if the pressure control deviation duration value exceeds the preset pressure control deviation duration threshold, generating the pressure control abnormal signal.

Further, if the pressure control deviation duration value does not exceed the preset pressure control deviation duration threshold, a region defined by a portion of the pressure curve located above the first ray and the first ray, as well as a region defined by a portion of the pressure curve located below the second ray and the second ray are marked as abnormal pressure regions;
an area of the corresponding abnormal pressure region is acquired and marked as an abnormal pressure surface detection value, the abnormal pressure surface detection values of all the abnormal pressure regions are summed to obtain a total abnormal pressure detection value, the abnormal pressure surface detection values are numerically compared with a preset abnormal pressure surface detection threshold, and if the abnormal pressure surface detection value exceeds the preset abnormal pressure surface detection threshold, the corresponding abnormal pressure region is marked as a pressure risk region, and the number of pressure risk regions is acquired and marked as a pressure risk detection value; and
a pressure control stability anomaly coefficient is calculated through weighted summation of the pressure control deviation duration value, the total abnormal pressure detection value, and the pressure risk detection value, the pressure control stability anomaly coefficient is numerically compared with a preset pressure control stability anomaly coefficient threshold, if the pressure control stability anomaly coefficient exceeds the preset pressure control stability anomaly coefficient threshold, the pressure control abnormal signal is generated, and if the pressure control stability anomaly coefficient does not exceed the preset pressure control stability anomaly coefficient threshold, the pressure control qualified signal is generated.

Further, the pressure control stability evaluation unit is in communication connection with a component pose monitoring and evaluation unit, the pressure control stability evaluation unit sends the pressure control qualified signal to the component pose monitoring and evaluation unit, and when receiving the pressure control qualified signal, the component pose monitoring and evaluation unit analyzes a pose condition of the photovoltaic packaging component, generates an abnormal pose signal or a pose qualified signal through analysis, and sends the abnormal pose signal or the pose qualified signal to the test management terminal.

Further, a specific analysis process of the component pose monitoring and evaluation unit is as follows:
in the test process, a pose image of the photovoltaic packaging component is acquired in real time, a current pose image is compared with a standard pose image before the testing to obtain a pose coincidence rate, the pose coincidence rate is numerically compared with a preset pose coincidence rate threshold, and if the pose coincidence rate exceeds the preset pose coincidence rate threshold, a poor pose symbol ZY-1 is assigned; and
the number of times of assignment of the poor pose symbol ZY-1 in a unit time is acquired and marked as a poor pose detection value, an average value of all pose coincidence rates in the unit time is calculated to obtain a pose performance evaluation value, the poor pose detection value and the pose performance evaluation value are numerically compared with a preset poor pose detection threshold and a preset pose performance evaluation threshold respectively, if the poor pose detection value exceeds the preset poor pose detection threshold or the pose performance evaluation value does not exceed the preset pose performance evaluation threshold, the abnormal pose signal is generated, and if the poor pose detection value does not exceed the preset poor pose detection threshold and the pose performance evaluation value exceeds the preset pose performance evaluation threshold, the pose qualified signal is generated.

Further, during the generation of the pose qualified signal, a vibration amplitude and a vibration frequency of the photovoltaic packaging component are collected and are numerically compared with a preset vibration amplitude threshold and a preset vibration frequency threshold respectively, and if the vibration amplitude or the vibration frequency exceeds the corresponding preset threshold, it is determined that the photovoltaic packaging component is in a vibration hidden danger state;
a total duration of the photovoltaic packaging component in the vibration hidden danger state in the unit time is acquired and marked as a vibration hidden danger duration, and an average value of vibration amplitudes and an average value of vibration frequencies in the unit time are marked as an amplitude characteristic value and a vibration frequency characteristic value respectively; and
a pose influence coefficient is calculated by performing weighted summation on the vibration hidden danger duration, the amplitude characteristic value, and the vibration frequency characteristic value, the pose influence coefficient is numerically compared with a preset pose influence coefficient threshold, and if the pose influence coefficient exceeds the preset pose influence coefficient threshold, a pose influence alarm signal is generated and is sent to the test management terminal.

Compared with the prior art, the present disclosure has the beneficial effects:
1. According to the present disclosure, a necessity degree of a package sealing performance test for the photovoltaic packaging component is reasonably determined to avoid wasting manpower and material resources by unnecessary testing. During the generation of the sealing low-hidden-danger signal, a water vapor permeability resistance condition of the photovoltaic packaging component is tested by simulating high humidity and pressure conditions in an actual use environment, and a quantitative basis is provided for the sealing performance evaluation. Pressure control monitoring is performed on the circulating pressure pump, and the pressure control stability of the circulating pressure pump is evaluated. During the generation of the pressure control abnormal signal, the test process is suspended as needed, and corresponding improvement measures are made, so as to significantly improve the accuracy of the test results, and reduce the difficulty of test supervision.
2. According to the present disclosure, the component pose monitoring and evaluation unit analyzes the pose condition of the photovoltaic packaging component when receiving the pressure control qualified signal, accurately evaluates a degree of adverse influence caused by a vibration condition on pose maintaining when the pose qualified signal is generated, and suspends the test process as needed when the abnormal pose signal or the pose influence alarm signal is generated, so as to avoid causing test abnormality or affecting the test stability and the accuracy of the test results, resulting in a high intelligence level is high, thereby further reducing the difficulty of test supervision.

### BRIEF DESCRIPTION OF THE DRAWINGS

For the convenience of understanding by those skilled in the art, the present disclosure is further described below in conjunction with the accompanying drawings.

FIG. 1 is a system block diagram of Embodiment 1 of the present disclosure; and

FIG. 2 is a system block diagram of Embodiment 2 and Embodiment 3 of the present disclosure.

### DETAILED DESCRIPTION OF THE EMBODIMENTS

Technical solutions in embodiments of the present disclosure will be clearly and completely described below in conjunction with the accompanying drawings in the embodiments of the present disclosure, and it is apparent that the described embodiments are only a part rather all of embodiments of the present disclosure. Based on the embodiments of the present disclosure, all other embodiments obtained by those of ordinary skill in the art without creative labor shall fall within the scope of protection of the present disclosure.

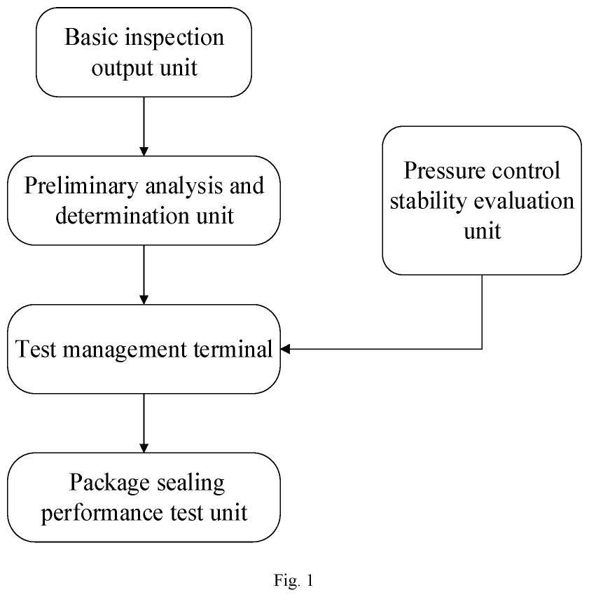

Embodiment 1: As shown in FIG. 1, a package sealing performance test system for a photovoltaic packaging component provided in the present disclosure includes a basic inspection output unit, a preliminary analysis and determination unit, a package sealing performance test unit, a pressure control stability evaluation unit, and a test management terminal.

The basic inspection output unit is configured to collect a surface image of a photovoltaic packaging component and send the surface image of the photovoltaic packaging component to the preliminary analysis and determination unit. The preliminary analysis and determination unit preliminarily determines a sealing hidden danger of the photovoltaic packaging component based on the surface image of the photovoltaic packaging component, and generates a sealing high-hidden-danger signal or a sealing low-hidden-danger signal based on the sealing hidden danger.

The sealing high-hidden-danger signal or the sealing low-hidden-danger signal is sent to the test management terminal, which can reasonably determine a necessity degree of a package sealing performance test for the photovoltaic packaging component, and remind test management personnel not to carry out the corresponding sealing performance test of the photovoltaic packaging component when the sealing high-hidden-danger signal is generated, so as to avoid wasting manpower and material resources by unnecessary testing. A specific determination process of the preliminary analysis and determination unit is as follows:

A crack on a surface of the photovoltaic packaging component is recognized based on the surface image of the photovoltaic packaging component, if the crack exists on the surface of the photovoltaic packaging component, it indicates that the sealing performance of the photovoltaic packaging component has a high hidden danger, testing the sealing performance of the photovoltaic packaging component is meaningless, and accordingly, the sealing high-hidden-danger signal is generated.

If no crack exists on the surface of the photovoltaic packaging component, bubbles on a bonding surface of colloid, glass, and a back plate are recognized based on the surface image of the photovoltaic packaging component, and if no bubbles exist on the bonding surface of the colloid, the glass, and the back plate, it indicates that the sealing performance of the photovoltaic packaging component has a low hidden danger, testing the sealing performance of the photovoltaic packaging component is meaningful, and accordingly the sealing low-hidden-danger signal is generated.

Further, if the bubbles exist on the bonding surface of the colloid, the glass, and the back plate, a volume of the corresponding bubbles is collected and marked as a bubble occupied space value, and the bubble occupied space value is numerically compared with a preset bubble occupied space threshold. If the bubble occupied space value exceeds the preset bubble occupied space threshold, it indicates that the corresponding bubbles have a significant adverse impact on the sealing performance of the photovoltaic packaging component, and the corresponding bubbles are marked as hidden danger bubbles.

If the hidden danger bubbles exist on the bonding surface of the colloid, the glass, and the back plate, the sealing high-hidden-danger signal is generated. If no hidden danger bubbles exist on the bonding surface of the colloid, the glass, and the back plate, the number of the bubbles on the bonding surface of the colloid, the glass, and the back plate is collected and marked as a bubble number detection value, and a proportion of a distribution area of the bubbles on the bonding surface of the colloid, the glass, and the back plate is marked as a bubble distribution value.

The bubble number detection value and the bubble distribution value are numerically compared with a preset bubble number detection threshold and a preset bubble distribution threshold respectively. If the bubble number detection value or the bubble distribution value exceeds the corresponding preset threshold, it indicates that the sealing performance of the photovoltaic packaging component has a high hidden danger, testing the sealing performance of the photovoltaic packaging component is meaningless, and accordingly, the sealing high-hidden-danger signal is generated. If the bubble number detection value and the bubble distribution value do not exceed the corresponding preset thresholds, it indicates that the sealing performance of the photovoltaic packaging component has a low hidden danger, the following sealing performance test may be performed, and accordingly, the sealing low-hidden-danger signal is generated.

When the sealing low-hidden-danger signal is generated, the package sealing performance test for the photovoltaic packaging component is performed through the package sealing performance test unit, the package sealing performance is determined after the test is completed, a package sealing performance determination result is sent to the test management terminal, a water vapor permeability resistance condition of the photovoltaic packaging component is tested by simulating high humidity and pressure conditions in an actual use environment, and a quantitative basis is provided for the sealing performance evaluation, so as to effectively test the sealing performance of the photovoltaic packaging component, improve the testing efficiency, and improve the accuracy of a sealing performance evaluation result. Specific test steps are as follows:

Sample fixation: The photovoltaic packaging component is fixed to an adhesive layer test frame to keep a sample stable during the test process, and prevent movement or deformation due to external force or air pressure changes, thereby facilitating the smooth progress of the test process and ensuring the accuracy of test results.

Placement in a pressure air chamber: The fixed sample is placed in the pressure air chamber, where the pressure air chamber is a sealed space for simulating an air pressure condition in the actual use environment and performing a water vapor permeability test, namely testing and evaluating the sealing performance of the photovoltaic packaging component.

Humidity gas injection: Humidity gas with a humidity of 80% is injected into a test gas storage tank, and this step is to simulate a high-humidity environment (the high-humidity environment is one of important conditions to test water vapor permeability resistance of the photovoltaic packaging component).

Circulating pressure pump startup: A circulating pressure pump is started to work, extracts the humidity gas from the test gas storage tank, and continuously inputs the humidity gas with pressure into an inner cavity of the pressure air chamber, and a pressure is controlled between 1.5×10⁵ Pa and 2.0×10⁵ Pa. This step is to simulate the air pressure changes in actual use and check the sealing performance of the photovoltaic packaging component under the pressure conditions.

Observation and value recording: After 30 minutes of operation, a value of a hygrometer in a sealed test chamber communicating with the pressure air chamber is collected, and a difference of humidity values before and after the test is recorded. This step is to quantify a water vapor permeation amount of the photovoltaic packaging component under specific time and pressure conditions.

Performance determination: According to the difference of the humidity values, the package sealing performance of the photovoltaic packaging component is determined, and if the humidity value difference is less than or equal to a preset humidity value difference threshold, it is determined that the package sealing performance of the photovoltaic packaging component is qualified; and if the humidity value difference is larger than the preset humidity value difference threshold, it is determined that the package sealing performance of the photovoltaic packaging component is not qualified.

The pressure control stability evaluation unit performs pressure control monitoring on the circulating pressure pump, evaluates the pressure control stability of the circulating pressure pump, generates a pressure control qualified signal or a pressure control abnormal signal accordingly, and sends the pressure control qualified signal or the pressure control abnormal signal to the test management terminal, and the test management terminal gives a corresponding early warning when receiving the pressure control abnormal signal to remind the test management personnel to suspend the test process as needed, investigate and analyze causes in time, and make corresponding improvement measures, so as to ensure the stability of an output gas pressure, further improve the accuracy of the test results, and significantly reduce the difficulty of test supervision. A specific analysis process of the pressure control stability evaluation unit is as follows:
a pressure curve of the humidity gas outputted by the circulating pressure pump in a unit time is acquired, and is placed into a first quadrant of a rectangular coordinate system, and a starting point of the pressure curve is located on a Y-axis, where an X-axis of the rectangular coordinate system represents time, and the Y-axis represents pressure;
in the first quadrant of the rectangular coordinate system, an upper ray and a lower ray that are parallel to the X-axis with endpoints on the Y-axis are drawn, a Y-axis coordinate value corresponding to the upper ray is 2.0×10⁵ Pa, a Y-axis coordinate value corresponding to the lower ray is 1.5×10⁵ Pa, and the upper ray and the lower ray are defined as a first ray and a second ray respectively; and
a Y-direction length value of a segment of the pressure curve that is not located between the first ray and the second ray is acquired and marked as a pressure control deviation duration value, the pressure control deviation duration value is numerically compared with a preset pressure control deviation duration threshold, and if the pressure control deviation duration value exceeds the preset pressure control deviation duration threshold, it indicates that a control condition of the circulating pressure pump for a gas output pressure is poor, which is not conducive to ensuring the stability of the test process and the accuracy of the test results, and accordingly, the pressure control abnormal signal is generated.

Further, if the pressure control deviation duration value does not exceed the preset pressure control deviation duration threshold, a region defined by a portion of the pressure curve located above the first ray and the first ray, as well as a region defined by a portion of the pressure curve located below the second ray and the second ray are marked as abnormal pressure regions.

An area of the corresponding abnormal pressure region is acquired and marked as an abnormal pressure surface detection value, and the abnormal pressure surface detection values of all the abnormal pressure regions are summed to obtain a total abnormal pressure detection value. The abnormal pressure surface detection values are numerically compared with a preset abnormal pressure surface detection threshold. If the abnormal pressure surface detection value exceeds the preset abnormal pressure surface detection threshold, the corresponding abnormal pressure region is marked as a pressure risk region. The number of pressure risk regions is acquired and marked as a pressure risk detection value.

A pressure control stability anomaly coefficient is calculated through weighted summation of the pressure control deviation duration value, the total abnormal pressure detection value, and the pressure risk detection value. Corresponding preset weight coefficients are assigned to the pressure control deviation duration value, the total abnormal pressure detection value, and the pressure risk detection value respectively. The pressure control deviation duration value, the total abnormal pressure detection value, and the pressure risk detection value are multiplied by the corresponding preset weight coefficients, and a sum of three products is marked as a pressure control stability anomaly coefficient. Moreover, a larger pressure control stability anomaly coefficient indicates a poorer control condition of the circulating pressure pump for the gas output pressure, which is more detrimental to ensuring the stability of the test process and the accuracy of the test results.

The pressure control stability anomaly coefficient is numerically compared with a preset pressure control stability anomaly coefficient threshold. If the pressure control stability anomaly coefficient exceeds the preset pressure control stability anomaly coefficient threshold, it indicates that the control condition of the circulating pressure pump for the gas output pressure is poor, which is detrimental to ensuring the stability of the test process and the accuracy of the test results, and accordingly, the pressure control abnormal signal is generated. If the pressure control stability anomaly coefficient does not exceed the preset pressure control stability anomaly coefficient threshold, it indicates that the control condition of the circulating pressure pump for the gas output pressure is good, which is conducive to ensuring the stability of the test process and the accuracy of the test results, and accordingly, the pressure control qualified signal is generated.

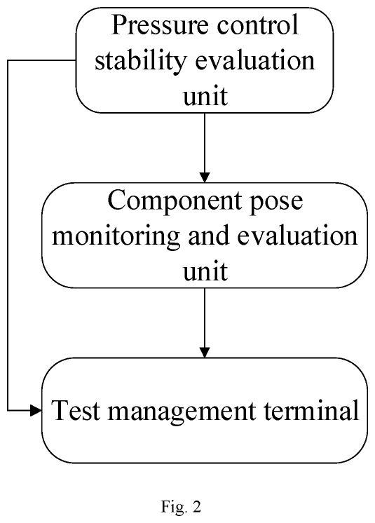

Embodiment 2: As shown in FIG. 2, a difference between this embodiment and Embodiment 1 is that the pressure control stability evaluation unit is in communication connection with a component pose monitoring and evaluation unit, the pressure control stability evaluation unit sends the pressure control qualified signal to the component pose monitoring and evaluation unit, and when receiving the pressure control qualified signal, the component pose monitoring and evaluation unit analyzes a pose condition of the photovoltaic packaging component, and generates an abnormal pose signal or a pose qualified signal in the test process through the analysis.

The abnormal pose signal or the pose qualified signal is sent to the test management terminal, and when receiving the abnormal pose signal, the test management terminal gives a corresponding early warning to remind the test management personnel to suspend the test process as needed, and adjust a fixed state of the photovoltaic packaging component to ensure a fixing effect, thereby avoiding the test abnormality caused by pose changes or the impact on the test stability and the accuracy of the test results, further reducing the difficulty of test supervision of the photovoltaic packaging component, and achieving a high intelligence level. It should be noted that a specific analysis process of the component pose monitoring and evaluation unit is as follows:
in the test process, a pose image of the photovoltaic packaging component is acquired in real time, a current pose image is compared with a standard pose image before the testing to obtain a pose coincidence rate, the pose coincidence rate is numerically compared with a preset pose coincidence rate threshold, and if the pose coincidence rate exceeds the preset pose coincidence rate threshold, it indicates that a current pose of the photovoltaic packaging component is greatly different from a pose standard requirement, and a poor pose symbol ZY-1 is assigned;
the number of times of assignment of the poor pose symbol ZY-1 in a unit time is acquired and marked as a poor pose detection value, an average value of all pose coincidence rates in the unit time is calculated to obtain a pose performance evaluation value, and the poor pose detection value and the pose performance evaluation value are numerically compared with a preset poor pose detection threshold and a preset pose performance evaluation threshold respectively; and
if the poor pose detection value exceeds the preset poor pose detection threshold or the pose performance evaluation value does not exceed the preset pose performance evaluation threshold, it indicates that the pose of the photovoltaic packaging component is unstable in the unit time, which is not conducive to ensuring the smooth progress of the test process and the accuracy of the test results, and accordingly the abnormal pose signal is generated, and if the poor pose detection value does not exceed the preset poor pose detection threshold and the pose performance evaluation value exceeds the preset pose performance evaluation threshold, it indicates that the pose of the photovoltaic packaging component is stable in the unit time, and accordingly the pose qualified signal is generated.

Embodiment 3: As shown in FIG. 2, a difference between this embodiment and Embodiments 1 and 2 lies in that, when the pose qualified signal is generated, a vibration amplitude and a vibration frequency of the photovoltaic packaging component are collected and are numerically compared with a preset vibration amplitude threshold and a preset vibration frequency threshold respectively, and if the vibration amplitude or the vibration frequency exceeds the corresponding preset threshold, it is determined that the photovoltaic packaging component is in a vibration hidden danger state;
a total duration of the photovoltaic packaging component in the vibration hidden danger state in the unit time is acquired and marked as a vibration hidden danger duration, and an average value of vibration amplitudes and an average value of vibration frequencies in the unit time are marked as an amplitude characteristic value and a vibration frequency characteristic value respectively;
a pose influence coefficient is calculated by performing weighted summation on the vibration hidden danger duration, the amplitude characteristic value, and the vibration frequency characteristic value, corresponding preset weight coefficients are assigned to the vibration hidden danger duration, the amplitude characteristic value, and the vibration frequency characteristic value respectively, the vibration hidden danger duration, the amplitude characteristic value, and the vibration frequency characteristic value are multiplied by the corresponding preset weight coefficients respectively, a sum of three products is marked as the pose influence coefficient, and moreover, a larger pose influence coefficient indicates a greater detriment to ensuring the pose stability of the photovoltaic packaging component; and
the pose influence coefficient is numerically compared with a preset pose influence coefficient threshold, if the pose influence coefficient exceeds the preset pose influence coefficient threshold, it indicates a detriment to ensuring the pose stability of the photovoltaic packaging component, accordingly, a pose influence alarm signal is generated and is sent to the test management terminal, and the test management terminal gives an early warning when receiving the pose influence alarm signal, so as to remind the test management personnel to suspend the test and re-fix the photovoltaic packaging component as needed, thereby ensuring the pose stability of the photovoltaic packaging component during the test process, and thus reducing the difficulty of monitoring and managing the test process.

A working principle of the present disclosure is as follows: during use, the basic inspection output unit is configured to collect the surface image of the photovoltaic packaging component, and the preliminary analysis and determination unit preliminarily determines the sealing hidden danger of the photovoltaic packaging component based on the surface image of the photovoltaic packaging component, which can reasonably determine the necessity degree of the package sealing performance test for the photovoltaic packaging component, and avoid wasting manpower and material resources by unnecessary testing. During the generation of the sealing low-hidden-danger signal, the water vapor permeability resistance condition of the photovoltaic packaging component is tested by simulating the high humidity and pressure conditions in the actual use environment, and the quantitative basis is provided for the sealing performance evaluation, so as to effectively test the sealing performance of the photovoltaic packaging component, improve the testing efficiency, and improve the accuracy of the sealing performance evaluation result. The pressure control stability evaluation unit performs pressure control monitoring on the circulating pressure pump and evaluates the pressure control stability of the circulating pressure pump, and during the generation of the pressure control abnormal signal, the test process is suspended as needed, and the corresponding improvement measures are made, so as to ensure the stability of the output gas pressure, further improve the accuracy of the test results, and significantly reduce the difficulty of test supervision

The preferred embodiments of the present disclosure disclosed above are merely intended to help illustrate the present disclosure. The preferred embodiments are not intended to exhaust all details, nor do they limit the present disclosure to only the described specific implementations. Apparently, many modifications and variations may be made in light of the content of the specification. In the specification, these embodiments are selected and specifically described to provide a better explanation of the principles and practical applications of the present disclosure, so that those skilled in the art can well understand and utilize the present disclosure. The present disclosure should be defined only by the claims, and the full scope and equivalents thereof.

What is claimed is:

1. A package sealing performance test system for a photovoltaic packaging component, comprising a basic inspection output unit, a preliminary analysis and determination unit, a package sealing performance test unit, a pressure control stability evaluation unit, and a test management terminal, wherein the basic inspection output unit is configured to collect a surface image of a photovoltaic packaging component, and the preliminary analysis and determination unit preliminarily determines a sealing hidden danger of the photovoltaic packaging component based on the surface image of the photovoltaic packaging component, and generates a sealing high-hidden-danger signal or a sealing low-hidden-danger signal based on the sealing hidden danger;
during the generation of the sealing low-hidden-danger signal, a package sealing performance test for the photovoltaic packaging component is performed through the package sealing performance test unit, the package sealing performance is determined after the test is completed, and a package sealing performance determination result is sent to the test management terminal; the pressure control stability evaluation unit performs pressure control monitoring on a circulating pressure pump, evaluates the pressure control stability of the circulating pressure pump, generates a pressure control qualified signal or a pressure control abnormal signal accordingly, and sends the pressure control qualified signal or the pressure control abnormal signal to the test management terminal;
a specific analysis process of the pressure control stability evaluation unit is as follows: a pressure curve of a humidity gas outputted by the circulating pressure pump in a unit time is acquired, and is placed into a first quadrant of a rectangular coordinate system, in the first quadrant of the rectangular coordinate system, an upper ray and a lower ray that are parallel to an X-axis with endpoints on a Y-axis are drawn, and the upper ray and the lower ray are defined as a first ray and a second ray respectively; and a Y-direction length value of a segment of the pressure curve that is not located between the first ray and the second ray is acquired and marked as a pressure control deviation duration value, and if the pressure control deviation duration value exceeds a preset pressure control deviation duration threshold, the pressure control abnormal signal is generated;
if the pressure control deviation duration value does not exceed the preset pressure control deviation duration threshold, a region defined by a portion of the pressure curve located above the first ray and the first ray, as well as a region defined by a portion of the pressure curve located below the second ray and the second ray are marked as abnormal pressure regions;
an area of the corresponding abnormal pressure region is acquired and marked as an abnormal pressure surface detection value, the abnormal pressure surface detection values of all the abnormal pressure regions are summed to obtain a total abnormal pressure detection value, the abnormal pressure surface detection values are numerically compared with a preset abnormal pressure surface detection threshold, and if the abnormal pressure surface detection value exceeds the preset abnormal pressure surface detection threshold, the corresponding abnormal pressure region is marked as a pressure risk region, and the number of pressure risk regions is acquired and marked as a pressure risk detection value; and
a pressure control stability anomaly coefficient is calculated through weighted summation of the pressure control deviation duration value, the total abnormal pressure detection value, and the pressure risk detection value, the pressure control stability anomaly coefficient is numerically compared with a preset pressure control stability anomaly coefficient threshold, if the pressure control stability anomaly coefficient exceeds the preset pressure control stability anomaly coefficient threshold, the pressure control abnormal signal is generated, and if the pressure control stability anomaly coefficient does not exceed the preset pressure control stability anomaly coefficient threshold, the pressure control qualified signal is generated.

2. The package sealing performance test system for the photovoltaic packaging component according to claim 1, wherein testing steps of the package sealing performance test unit are as follows:
sample fixation; placement into a pressure air chamber; humidity gas injection; circulating pressure pump startup; observation and value recording; and performance determination.

3. The package sealing performance test system for the photovoltaic packaging component according to claim 2, wherein during the performance determination, if a humidity value difference is less than or equal to a preset humidity value difference threshold, it is determined that the package sealing performance of the photovoltaic packaging component is qualified; and
if the humidity value difference is larger than the preset humidity value difference threshold, it is determined that the package sealing performance of the photovoltaic packaging component is not qualified.

4. The package sealing performance test system for the photovoltaic packaging component according to claim 1, wherein a specific determination process of the preliminary analysis and determination unit comprises:
recognizing a crack on a surface of the photovoltaic packaging component based on the surface image of the photovoltaic packaging component, and if the crack exists on the surface of the photovoltaic packaging component, generating the sealing high-hidden-danger signal; and
if no crack exists on the surface of the photovoltaic packaging component, recognizing bubbles on a bonding surface of colloid, glass, and a back plate based on the surface image of the photovoltaic packaging component, and if no bubbles exist on the bonding surface of the colloid, the glass, and the back plate, generating the sealing low-hidden-danger signal.

5. The package sealing performance test system for the photovoltaic packaging component according to claim 4, wherein if the bubbles exist on the bonding surface of the colloid, the glass, and the back plate, a bubble occupied space value is numerically compared with a preset bubble occupied space threshold, and if the bubble occupied space value exceeds the preset bubble occupied space threshold, the corresponding bubbles are marked as hidden danger bubbles; and
if the hidden danger bubbles exist on the bonding surface of the colloid, the glass, and the back plate, the sealing high-hidden-danger signal is generated, if no hidden danger bubbles exist on the bonding surface of the colloid, the glass, and the back plate, a bubble number detection value and a bubble distribution value are numerically compared with a preset bubble number detection threshold and a preset bubble distribution threshold respectively, if the bubble number detection value or the bubble distribution value exceeds the corresponding preset threshold, the sealing high-hidden-danger signal is generated, and if not, the sealing low-hidden-danger signal is generated.

6. The package sealing performance test system for the photovoltaic packaging component according to claim 1, wherein the pressure control stability evaluation unit is in communication connection with a component pose monitoring and evaluation unit, and when receiving the pressure control qualified signal, the component pose monitoring and evaluation unit analyzes a pose condition of the photovoltaic packaging component, and sends an abnormal pose signal or a pose qualified signal to the test management terminal.

7. The package sealing performance test system for the photovoltaic packaging component according to claim 6, wherein a specific analysis process of the component pose monitoring and evaluation unit is as follows:
in a test process, a pose image of the photovoltaic packaging component is acquired in real time, a current pose image is compared with a standard pose image before the testing to obtain a pose coincidence rate, the pose coincidence rate is numerically compared with a preset pose coincidence rate threshold, and if the pose coincidence rate exceeds the preset pose coincidence rate threshold, a poor pose symbol ZY-1 is assigned; and
the number of times of assignment of the poor pose symbol ZY-1 in a unit time is acquired and marked as a poor pose detection value, an average value of all pose coincidence rates in the unit time is calculated to obtain a pose performance evaluation value, the poor pose detection value and the pose performance evaluation value are numerically compared with a preset poor pose detection threshold and a preset pose performance evaluation threshold respectively, if the poor pose detection value exceeds the preset poor pose detection threshold or the pose performance evaluation value does not exceed the preset pose performance evaluation threshold, the abnormal pose signal is generated, and if the poor pose detection value does not exceed the preset poor pose detection threshold and the pose performance evaluation value exceeds the preset pose performance evaluation threshold, the pose qualified signal is generated.

8. The package sealing performance test system for the photovoltaic packaging component according to claim 7, wherein during the generation of the pose qualified signal, a pose influence coefficient is calculated by performing weighted summation on a vibration hidden danger duration, an amplitude characteristic value, and a vibration frequency characteristic value, and if the pose influence coefficient exceeds a preset pose influence coefficient threshold, a pose influence alarm signal is generated.
